(19) United States
(12) Patent Application Publication
(10) Pub. No.: US 2007/0257520 A1
(43) Pub. Date: Nov. 8, 2007

(54) Vehicle trim panel

(75) Inventors: Michael R. Catlin, Holland, MI (US); Scott A. Hansen, Holland, MI (US); Ronald A. Bozio, Holland, MI (US); Nels R. Smith, Holland, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/799,681

(22) Filed: May 2, 2007

Related U.S. Application Data
(60) Provisional application No. 60/796,793, filed on May 2, 2006.

(51) Int. Cl. B60J 7/00

(52) U.S. Cl. 296/214

(57) ABSTRACT

A vehicle trim panel for use in a vehicle having an interior portion includes a first substrate panel. A first cover is coupled to the first substrate panel. A second substrate panel is coupled to the first substrate panel. A second cover is coupled to the second substrate panel, wherein the first and second substrate panels are aligned in the vehicle with the first and second covers exposed to the interior portion of the vehicle.

### CROSS-REFERENCE TO RELATED APPLICATIONS

This application claims priority to U.S. Provisional Application No. 60/796,793, filed May 02, 2006, which is incorporated herein by reference.

### BACKGROUND

The present application relates generally to the field of vehicle interior panels. In particular, the present application relates to a vehicle trim panel, such as a headliner, having multiple materials and different colors.

Vehicle headliners generally include a substrate and a cover. The substrate provides structural strength for the headliner. The cover, which may be a fabric or other material, may be laminated onto the substrate by use of an adhesive. The cover is usually selected to have color and/or texture that matches or coordinates with other trim panels or the upholstery in the vehicle. Headliners typically are produced having a single color and comprise a single cover. Such headliners do not allow for a headliner having multiple colors and/or materials that may better coordinate with the rest of a vehicle interior.

Trim panels, including headliners, also are incorporating more and more accessories. These accessories may include sunroofs, in-vehicle entertainment systems, telematics devices, side curtain air bags, and a variety of other accessories. Many headliner materials are rigid and can be difficult to manipulate around accessories during manufacture or installation. Further, to accommodate a variety of trim levels within a single vehicle model, a number of completely different headliners may be required.

Accordingly, it would be desirable to provide a trim panel capable of accommodating a plurality of cover materials. It would be desirable to provide a trim panel system that may be used to accommodate a variety of trim levels for the same vehicle model.

### SUMMARY

According to an exemplary embodiment, a vehicle trim panel for use in a vehicle having an interior portion includes a first substrate panel. A first cover is coupled to the first substrate panel. A second substrate panel is coupled to the first substrate panel. A second cover is coupled to the second substrate panel, wherein the first and second substrate panels are aligned in the vehicle with the first and second covers exposed to the interior portion of the vehicle.

According to another exemplary embodiment, a method of making a vehicle trim panel includes coupling a first cover to a first substrate panel and coupling a second cover to a second substrate panel. An arcuate portion is formed along an edge of the first substrate panel. An arcuate portion is formed along an edge of the second substrate panel. The arcuate portions of each of the first and seconds substrate panels are joined to each other to form the vehicle trim panel.

According to another exemplary embodiment, a vehicle trim panel for use in a vehicle interior includes a substrate panel defining a channel. A first cover is coupled to the substrate panel, wherein a portion of the cover is disposed in the channel. Another embodiment includes a second cover, and both the first and second channels are disposed in the channel.

### BRIEF DESCRIPTION OF THE DRAWINGS

FIG. 1 is a perspective view of an exemplary embodiment of a trim panel, for example, a headliner for a vehicle.

FIG. 2 is a schematic perspective view of an exemplary embodiment of a process for producing the headliner of FIG. 1.

FIG. 3 is an elevation view of an exemplary embodiment of a trim panel composed of two different materials.

FIG. 4 is a cross-sectional view of the trim panel illustrated in FIG. 3 taken along seam line 4-4 which is parallel to the longitudinal axis of a vehicle headliner.

FIG. 5 is an elevation view of an exemplary embodiment of a trim panel composed of multiple, co-extruded materials.

FIG. 6 is a cross-sectional view of the trim panel illustrated in FIG. 5 illustrating a “false stitch” feature, taken along line 6-6 which is perpendicular to the longitudinal axis of a vehicle headliner.

### DETAILED DESCRIPTION

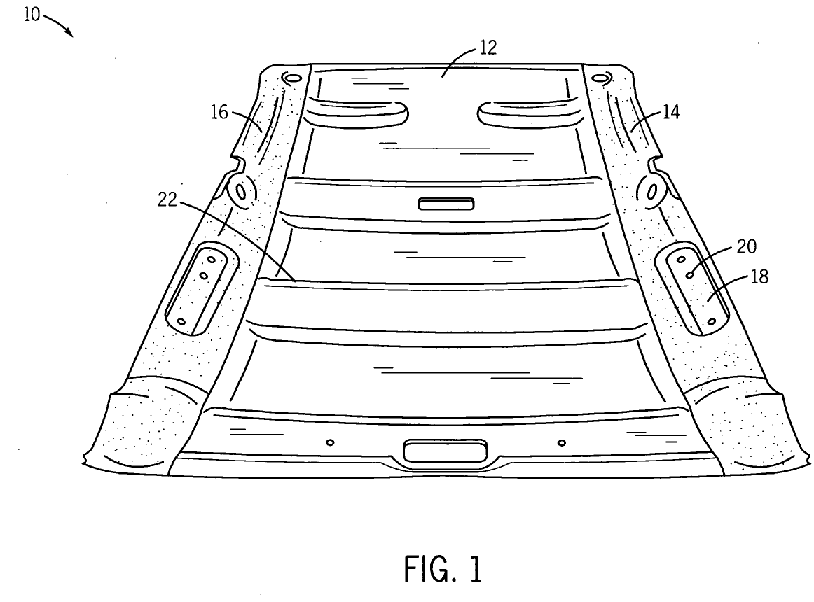

FIGS. 1-6 illustrate exemplary embodiments of a trim panel for use in a vehicle (e.g., an automobile such as a car, truck, sport utility vehicle, minivan bus, and the like; airplanes; and/or boats). In one embodiment, the trim panel is configured as a headliner for use in an automobile.

Referring to FIG. 1, headliner 10 includes middle portion 12, side portion 14, and side portion 16. Middle portion 12, side portion 14, and/or side portion 16 may be provided with detents 18, openings 20, ridges 22, and/or other structural elements to accommodate various vehicle accessories or structural elements. Each of portions 12, 14, and 16 may be formed separately and then joined together to form headliner 10.

Alternatively, portions 12, 14, and 16, may be formed as a single unitary body. In some embodiments, it may be desirable to provide a headliner having a substrate and a cover formed as a laminate or other composite. In other embodiments, the headliner, or one or more portions thereof, may comprise a single layer assembly. Portions 12, 14, and 16 are shown as configured to extend along a longitudinal axis of the vehicle in the direction of vehicle travel. Alternatively, the portions may be arranged laterally or non-orthogonally to the longitudinal axis of the vehicle.

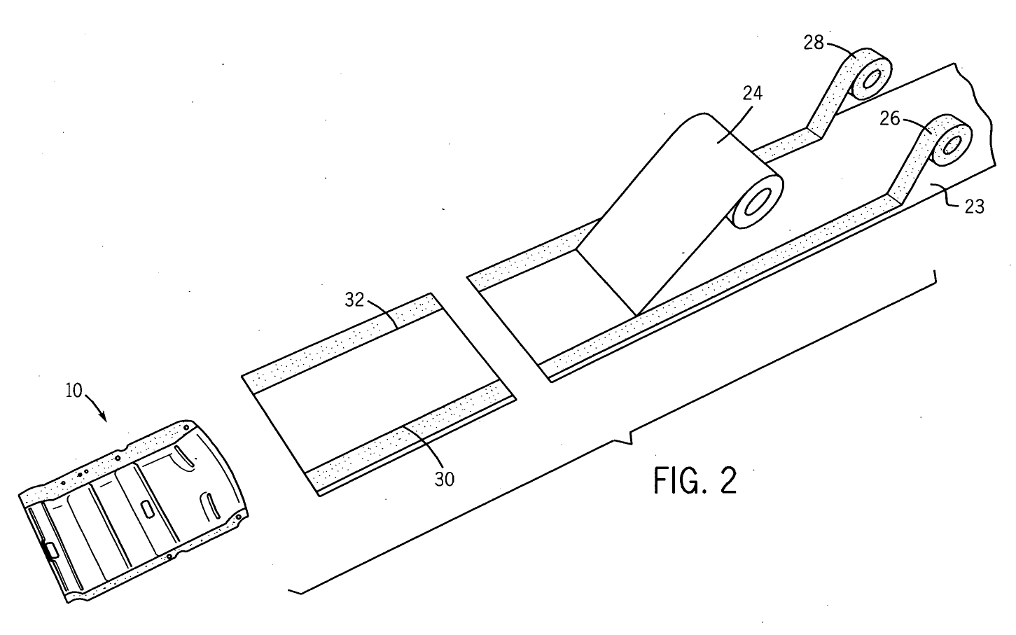

Referring to FIG. 2, an exemplary embodiment of a process for producing headliner 10 is illustrated. Material rolls 24, 26, and 28 provide material for covering a substrate 23 at middle portion 12, side portion 14, and side portion 16 of headliner 10, respectively. The materials from rolls 24, 26, and 28 are combined longitudinally to cover a substrate material. The coverings of middle portion 12 and side portions 14 and 16 may be coupled in a variety of manners. For example, seams 30 may be provided to join the covering of middle portion 12 and the coverings of side portions 14 and 16. Alternatively, the coverings of side portion 14 and/or side portion 16 may overlap an edge of the cover of middle portion 12 to form a joint 32 where side portions 14 and/or 16 may be joined to middle portion 12.

The material used to form the cover of the middle portion 12 and side portion 14 and/or 16 of the trim panel may be any one of a number of thermal setting or thermal forming materials. Such materials include polymers selected from the group consisting of polyethylene teraphthalate (“PET”), polypropylene, and derivatives and mixtures thereof. Alternatively, other suitable materials may be used as well. For example, any of a variety of biodegradable and/or recyclable materials may be used. The materials may be provided with a variety of surface finishes. For example, the material may have a brushed appearance. Alternatively, the material may have a flat or simulated finish or have some other textured finish.

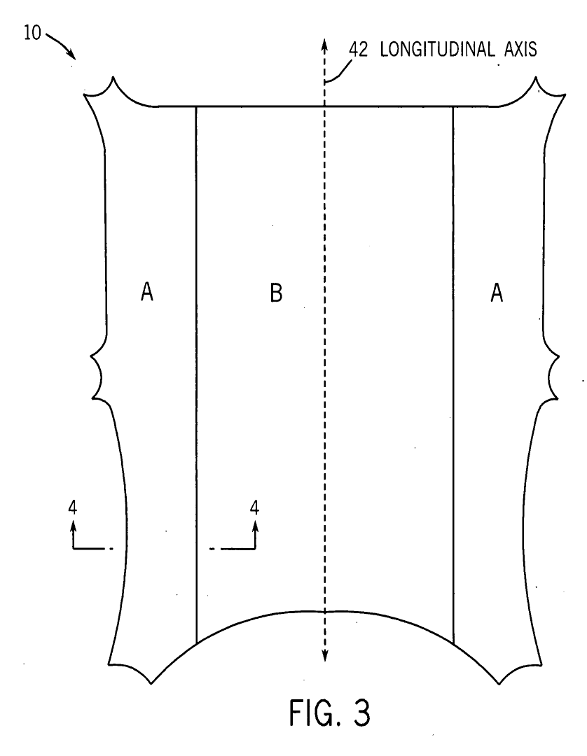

For reference purposes, the longitudinal axis 42 of headliner 10 is illustrated in FIGS. 3 and 5. Longitudinal axis 42 of headliner 10 is configured to align with the longitudinal axis of a vehicle along a direction of vehicle travel.

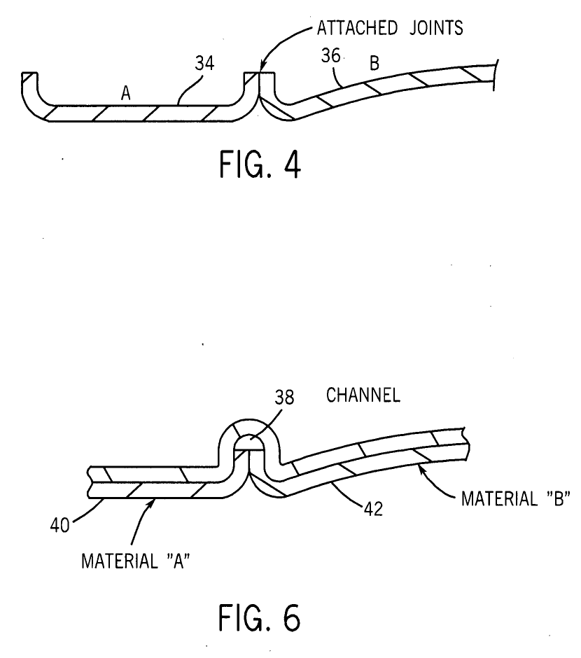

Referring to FIG. 3, a trim panel shown as a headliner includes middle portion B and side portions A. Referring to FIG. 4, the joint between side portion A and middle portion B is illustrated. According to the embodiment shown, a seam is provided between side portion A and middle portion B. Side portion A includes an arcuate portion 34 that joins to arcuate portion 36 of middle portion B at an interface or a contact surface between side portion A and middle portion B. Side portion A and middle portion B may be coupled along this interface by a variety of means. For example, side portion A and middle portion B may be stitched together by stitching which passes through arcuate portion 34 and arcuate portion 36. The stitching may be real, e.g., using a suitable thread, or simulation stitching, e.g. stitch feature formed in a mold. Alternatively, arcuate portion 34 and arcuate portion 36 may be joined by an adhesive along the interface. In yet another embodiment, side portion A and middle portion B may be coupled by ultrasonic welding, heat welding, and/or other applicable attachment methods.

Portions A and B may be individually covered with a polymeric cover. Alternatively, portions A and B may be covered with another material such as a non-woven fabric, woven fabric, polyvinylchloride (“PVC”), leather, or other suitable material. When an uncovered substrate is used in the headliner, the surface of the uncovered substrate may be provided with a textured finish or a decorative pattern in the surface.

Referring to FIG. 5, a trim panel shown as a headliner may include alternating panels A and B. Alternating panels A and B are joined along seams.

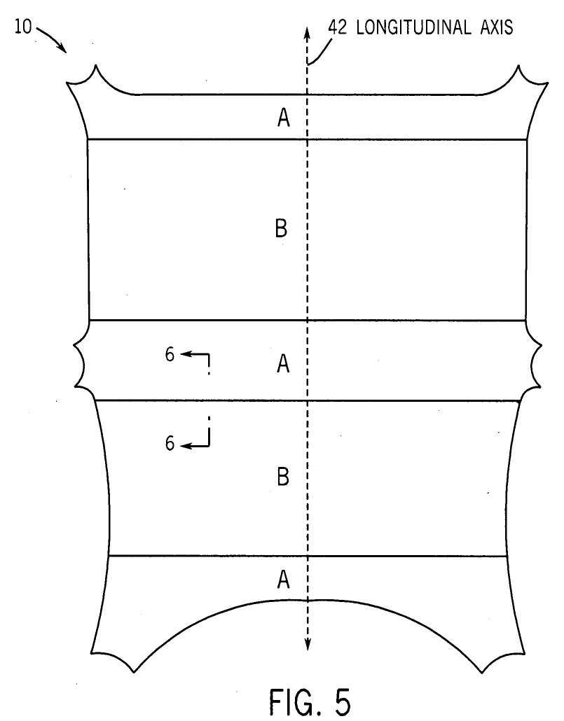

FIG. 6 illustrates one embodiment of the seam for attaching alternating materials A and B. According to this embodiment, the headliner includes a single substrate, and a channel 38 is provided in substrate to receive a cover material. The cover material may comprise one or more materials. For example, cover portion 40 may comprise a material A and cover portion 42 may comprise a material B. Cover portions 40 and 42 provide an interface between material A and material B and may be joined together by any of the methods discussed above. Alternatively, cover portions 40 and 42 may be held in the channel by friction, by adhesive joining of each of materials A and B to the substrate, or by co-lamination of materials A and B to the substrate.

In another embodiment, a single cover portion may be used (i.e., a co-extruded material having two color portions A and B). Such a co-extruded material may include a boundary region between portion A and portion B where the colors bleed and/or otherwise mix together. In order to provide a clean boundary between the two color regions for a headliner type trim panel, the boundary region may be disposed within the channel, ditch joint, or other structure in the substrate. This allows for concealment of the boundary region which may include an area where colors have bled together. The channel may be formed during the extrusion process, i.e., by selecting a die having a cross-section configured to provide the channel. Alternatively, the channel may be formed by bending or warping a flat panel such that the boundary region is disposed within a channel or ditch. Headliner 10 may also be manufactured by injection molding processes to form portions 12, 14, and 16. In other embodiments, the trim panel may be formed by compression molding.

Headliner 10 may be configured to accommodate a vehicle accessory, such as a power and/or communication system including lighting, compass systems, telematics systems, integrated transceivers, and other such devices and systems. Headliner 10 may also accommodate other devices including visors, air bags, grab handles, and other devices. Headliner 10 may be configured to receive such devices by use of any suitable attachment method, such as threaded fasteners and back brackets or clips, adhesive (e.g. hot-melt glue, etc.), Christmas tree type fasteners or any other suitable method. Appropriate sized and positioned openings 20 in the trim panel are provided to receive the various types of vehicle accessories. The openings 20 can be formed during the manufacturing process of the trim panel or cut out after the trim panel is formed.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components, or the two components and any additional member being attached to one another. Such joining may be permanent in nature or alternatively may be removable or releasable in nature

The construction and arrangement of the elements of the trim panel system and apparatus as shown in the exemplary embodiments is illustrative only. Although only a few embodiments of trim panels have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements, the position of elements may be reversed or otherwise varied, and the nature or number of discrete elements or positions may be altered or varied. It should be noted that the elements and/or assemblies of the trim panel may be constructed from any of a wide variety of materials that provide sufficient strength or durability, including any of a wide variety of moldable plastic materials (such as high-impact plastic) in any of a wide variety of colors, textures and combinations. Further, the trim panel may be configured to interface with a wide variety of other vehicle accessories. Other substitutions, modifications, changes and omissions may be made in the design of the exemplary embodiments without departing from the scope of the claims.

What is claimed is:

1. A vehicle trim panel for use in a vehicle having an interior portion, the vehicle trim panel comprising:
a first substrate panel;
a first cover coupled to the first substrate panel;
a second substrate panel coupled to the first substrate panel; and
a second cover coupled to the second substrate panel,
wherein the first and second substrate panels are aligned in the vehicle with the first and second covers exposed to the interior portion of the vehicle.

2. The vehicle trim panel of claim 1 wherein the first and second substrates each define an arcuate portion, and wherein the arcuate portions join each other to define a seam.

3. The vehicle trim panel of claim 2 further comprising a stitch passing through at least one of the arcuate portions of each of the first and second substrates.

4. The vehicle trim panel of claim 1 wherein the first cover includes a first color and the second cover includes a second color different from the first color.

5. The vehicle trim panel of claim 1 wherein the first and second substrates comprise bio-degradable material.

6. The vehicle trim panel of claim 1 wherein the first and second substrates form a headliner.

7. The vehicle trim panel of claim 6 wherein the headliner includes an opening configured to receive a vehicle accessory.

8. The vehicle trim panel of claim 1 including at least one additional substrate panel coupled to one of the first and second substrate panels.

9. A method of making a vehicle trim panel comprising the steps of:
coupling a first cover to a first substrate panel;
coupling a second cover to a second substrate panel;
forming an arcuate portion along an edge of the first substrate panel;
forming an arcuate portion along an edge of the second substrate panel;
joining the arcuate portions of each of the first and second substrate panels to each other to form the vehicle trim panel.

10. The method of claim 9 wherein joining includes applying an adhesive to each arcuate portion.

11. The method of claim 9 wherein joining includes stitching the arcuate portions.

12. A vehicle trim panel for use in a vehicle interior, the vehicle trim panel comprising:
a substrate panel defining a channel; and
a first cover coupled to the substrate panel,
wherein a portion of the cover is disposed in the channel.

13. The vehicle trim panel of claim 12 including a second cover coupled to the substrate panel, with a portion of the second cover disposed in the channel with the first cover.

14. The vehicle trim panel of claim 13 including an adhesive disposed in the channel with the adhesive in contact with each of the first and second covers and the substrate.

15. The vehicle trim panel of claim 12 wherein the first cover defines at least two portions, with one portion having a first color and the other portion having a second color different from the first color, wherein a boundary between the first and second colors is defined.

16. The vehicle trim panel of claim 15 wherein the boundary is aligned with the channel.

17. The vehicle trim panel of claim 12 wherein the substrate comprises of bio-degradable material.

18. The vehicle trim panel of claim 12 wherein the substrate forms a headliner.

19. The vehicle trim panel of claim 18 wherein the headliner includes an opening configured to receive a vehicle accessory.

20. The vehicle trim panel of claim 18 wherein the cover is exposed to the vehicle interior.
